(19) United States
(12) Patent Application Publication
(10) Pub. No.: US 2023/0183273 A1
(43) Pub. Date: Jun. 15, 2023

(54) HIGH PURITY POLYSILOXANE MACROMERS AND METHOD FOR MAKING THE SAME

(71) Applicant: Gelest, Inc., Morrisville, PA (US)

(72) Inventors: Barry C. ARKLES, Pipersville, PA (US); Jonathan D. GOFF, Philadelphia, PA (US)

(21) Appl. No.: 17/551,252

(22) Filed: Dec. 15, 2021

(51) Int. Cl. C07F 7/12; C08G 77/24

(52) U.S. Cl. CPC C07F 7/125; C08G 77/24

(57) ABSTRACT

A method of synthesizing a high purity acryloxyalkyldimethylchlorosilane involves (a) reacting an acrylate salt with a haloalkyldimethylalkoxysilane to form an acryloxy-substituted alkyldimethylalkoxysilane; and (b) displacing the alkoxy group in the acryloxy-substituted alkyldimethylalkoxysilane using a chloride-containing compound to form the acryloxyalkyldimethylchlorosilane. The acryloxyalkyldimethylchlorosilane, which may be used as an end-capper for AROP, has a purity of greater than about 99% and contains no detectable isomeric or hydrogenated impurities.

### BACKGROUND OF THE INVENTION

Acrylate functional polysiloxane macromers continue to find applications in which the precise control of mechanical, optical or electrical properties is essential in end-use. The most common siloxane macromer, mono-methacryloxypropylterminated polydimethylsiloxane, is most commonly referred to as MPDMS or MCR-M11 and has formula (1).

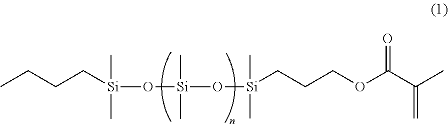

Impurities found in acrylate functional polysiloxane macromers frequently have deleterious impacts on final applications. Similar issues occur in variations of the most commonly used macromers including, for example, macromers containing backbones with trifluoropropyl substitution and those having symmetric structures, such as macromers having formulas (2) and (3).

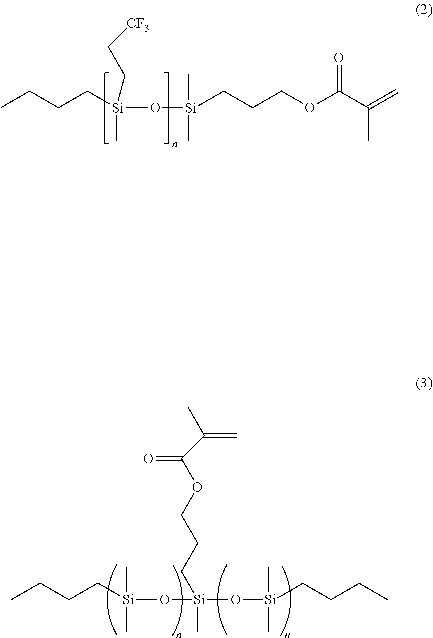

For example, isomeric impurities lead to non-homogeneity in copolymer structures and inert impurities may lead to extractable species which may affect biocompatibility or result in domain separation that affects the optical properties of copolymers.

Polysiloxane macromers are formed by living anionic ring-opening polymerization (AROP). This chemistry is described by Goff et al. (see “Applications of Hybrid Polymers Generated from Living Anionic Ring Opening Polymerization,” Molecules, 26, 2755 (2021)). The conditions for avoiding redistribution reactions during the polymerization that forms the siloxane-containing macromer are critical for achieving purity, but most of these variables are now understood. The most significant limit to achieving high-purity is the “end-capper” or “termination” reagent employed in the AROP reaction: 3-(methacryloxy)propyldimethylchlorosilane, having formula (4).

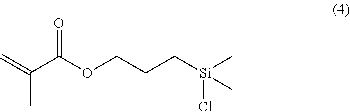

This end-capper material is conventionally produced by the hydrosilylation of allyl methacrylate. The earliest discrete synthesis for the product was reported by Cameron (Polymer, 26, 437 (1985)) in 50% yield with final purity unspecified. Unfortunately, the reaction is not clean and the reaction mixture is not readily purified due not only to the close boiling points of the products but also the tendency to polymerize during processing. A major byproduct is the 3-isomer, 1-methyl-2-methacryloxyethyldimethylchlorosilane, (formula (5)).

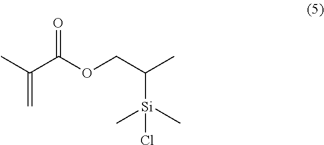

Other byproducts include the hydrogenated analogs of the desired 3-(methacryloxy)propyldimethylchlorosilane and of the 0-isomer. The hydrogenated analog of the desired product, isobutyroxypropyldimethylchlorosilane, has formula (6).

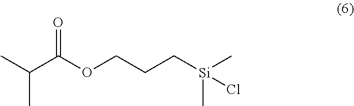

The genesis of these impurities is the selectivity of the hydrosilylation catalyst which, although favoring the anti-Markovnikov addition product, also allows the formation of the normal Markovnikov product, allows minor dehydrogenative coupling reactions, and catalyzes hydrogenation of the double bond of the acrylate. The hydrosilylation is preferred, but not limited to the allylic group, and, to a lesser degree, also occurs with the unsaturation of the acrylate. Although there is allylic unsaturation in the product formed by hydrosilylation of the acrylate double bond, under normal polymerization conditions it is essentially unreactive with the consequence that macromers derived from this byproduct are also extractable. For example, unlike methacrylate functional macromers, allyl functional macromers do not readily undergo photoinitiated polymerization.

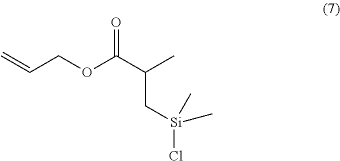

Additionally, a major byproduct formed by elimination of propylene is methacryloxydimethylchlorosilane (formula (8)), which can undergo exchange reactions with chlorine bound to silicon to yield the compound having formula (9).

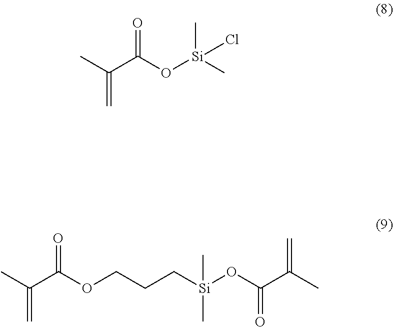

This description of impurities is not meant to be exhaustive, but rather indicative of many of the issues involved and the difficulties in generating high purity macromers from acryloxy functional endcappers produced by hydrosilylation.

Apart from the obvious structural impurities caused by the incorporation of structural analogs of the end-capper into the desired macromer, difficulties arise in determining the exact amount of end-capper required to achieve molecular weight control. Obtaining high yields and high purity of the end-capper is critical in both economics and performance.

A method for obtaining higher yields of 3-(methacryloxy)propyldimethylchlorosilane was reported by Cracknell (WO 2016/005757), in which byproducts were minimized by a process control method utilizing the same basic chemistry. However, the reported purity of the isolated product was only 89%, and there is no recognition or report of isomeric or hydrogenated byproducts. More detailed syntheses are reported in U.S. Pat. No. 5,847,178 of Okawa and U.S. Pat. No. 5,811,565 of Mikami, in which it was demonstrated that purities as great as 98.8% could, in a post-synthetic step, be achieved by decomposing the 0-isomer by the addition of a copper reagent. More recently, JP 2003-096086 of Nishiwaki describes the use of an iridium catalyst, which also resulted in a purity of 98.8%. It should be noted that only one of the earlier reported syntheses (U.S. Pat. No. 5,493,039 of Okawa) noted as a baseline or as an improvement the reduced amount of the reduced analog of the target compound, isobutyroxypropyldimethylchlorosilane (also known as α-methylpropionyloxypropyldimethylchlorosilane), presumably due to the inability to identify this product with older gas chromatographic techniques. Further, all of the earlier literature reports of high purities are likely overstated, at least because at the time of these references, analytical limitations typically lacked the sensitivity to determine hydrogenated and isomeric byproducts and failure to meet performance criteria appeared inexplicable.

The reduced byproducts are particularly problematic since they introduce non-polymerizable, extractable impurities into articles produced from the nominally pure methacrylate functional polysiloxane macromer. To date, no method via hydrosilylation or any other reaction pathway produces meth(acryloxy)alkyldimethylchlorosilanes which are free of isomeric or hydrogenated byproducts, making them suitable for critical applications. For example, in optical applications such as contact lenses, these classes of impurities can result in loss of transparency and eye irritation by allowing migration, phase separation, or extraction of the unreacted polymeric species that act as contaminants in an otherwise fully polymerizable macromer. Accordingly, it would be highly desirable to be able to produce acryloxyalkyldimethylchlorosilanes in high yield with no detectable isomeric or hydrogenated byproducts.

### SUMMARY OF THE INVENTION

In one aspect of the disclosure, provided is an acryloxyalkyldimethylchlorosilane having a purity of at least about 99% and containing less than about 0.1 wt. % hydrogenated byproducts and less than about 0.1 wt. % isomeric byproducts.

In another aspect of the disclosure, provided is a method of synthesizing a high purity acryloxyalkyldimethylchlorosilane comprising:

(a) reacting an acrylate salt with a haloalkyldimethylalkoxysilane to form an acryloxy-substituted alkyldimethylalkoxysilane; and

(b) displacing the alkoxy group in the acryloxy-substituted alkyldimethylalkoxysilane using a chloride-containing compound to form the acryloxyalkyldimethylchlorosilane.

In a further aspect of the disclosure, provided is a methacrylate-functional macromer or copolymer derived from an acryloxyalkyldimethylchlorosilane, wherein the macromer or copolymer has a purity of at least about 99%.

### DETAILED DESCRIPTION OF THE INVENTION

The disclosure relates to a method for synthesizing high purity acryloxyalkyldimethylchlorosilanes, which are suitable end-cappers for living AROP. These high purity compounds are substantially free of isomers and hydrogenated byproducts and allow for the preparation of high purity acryloxyalkyl terminated poly(siloxanes) which are substantially free of non-polymerizable polysiloxanes. The method of this disclosure avoids hydrosilylation of an acrylate, and instead utilizes substitution reactions in which there is no chemical mechanism for isomerization or reduction. In a preferred embodiment, the end-capper produced by the method is 3-methacryloxypropyldimethylchlorosilane (formula (4)) with a purity of about 99% or greater and contains no detectable hydrogenated analog (isobutyroxypropyldimethylchlorosilane, having formula (6)) or the p-isomer (1-methyl-2-methacryloxyethyldimethylchlorosilane, having formula (5)). This high purity compound may be used as an end-capper or terminator for the production of monomethacryloxypropyl terminated polydimethylsiloxanes. Other examples of high purity compounds suitable as end-cappers or termination reagents for the living AROP synthesis of macromers which may be synthesized by the method described herein include (methacryloxymethyl)dimethylchlorosilane and 3-(acryloxymethyl)dimethylchlorosilane, which have not heretofore been synthesized.

In all cases, the compounds described herein are substantially free of isomeric and hydrogenated byproducts/reductive analogs. The negative effects of impure end-capping compounds are most significant when the macromers are of relatively low molecular weight, in particular less than about 5,000 Daltons. At high molecular weights, the non-reactive macromers formed from reductive analogs can be solubilized in a final polymer in which the macromer forms a pendant group in a copolymer. With copolymers derived from low molecular weight macromers, a loss of optical transmission caused by phase separation of the reductive analog may occur. The materials and methods described herein solve the problem of defects in optics which are associated with low molecular weight macromers incorporated as comonomers in polymers utilized in the formation of contact lenses.

For the purposes of this disclosure, the term “high purity” may be understood to mean a purity greater than about 99%, more preferably greater than about 99.2%, even more preferably greater than about 99.3%. The term “substantially free” may be understood to mean that the impurity is not detectable by GC and GC-MS, which typically have detection limits of less than about 0.05 wt. %. Accordingly, the method provides for the synthesis of acryloxyalkyldimethylchlorosilanes having high purity and also no detectible isomeric or hydrogenated byproducts, that is, less than about 0.1 wt. % or less than about 0.05 wt. % isomeric or hydrogenated byproducts. Other impurities which may be present will have little impact on AROP or in the performance of the resulting macromers.

The method for synthesizing the high purity acryloxyalkyldimethylchlorosilanes involves (a) forming an acryloxy-substituted alkyldimethylalkoxysilane, preferably by a phase transfer catalyzed reaction between an acrylate salt and a (haloalkyl)dimethylalkoxysilane, and then (b) displacing the alkoxy group with a halide, preferably in an exchange or substitution reaction. In step (a), a preferred acrylate salt is potassium methacrylate, which may be generated in-situ from the reaction of potassium carbonate and methacrylic acid, for example. A preferred (haloalkyl)dimethylalkoxysilane is 3-chloropropyldimethylethoxysilane. Alternatively, but less preferred, an acrylic acid may be reacted with a haloalkylsilane in the presence of a base acceptor. However, this chemistry cannot directly produce the preferred methacryloxypropyldimethylchlorosilane because the acrylate salt also reacts with the chlorine bound to silicon. Thus, it has been found that generating a methacryloxypropyldimethylalkoxysilane is a practical intermediate. In a preferred embodiment, the high purity end-capper is a (meth)acryloxypropyldimethylchlorosilane and the intermediate is a (meth)acryloxypropyldimethylethoxysilane.

There are a number of known synthetic methods which may be employed for converting an alkoxy group bound to a silicon to a halide in the second reaction step (b). For example, an ethoxy group on silicon may be exchanged with chlorine by reaction with thionyl chloride, phosphoryl trichloride, phosphorous pentachloride, benzyl chloride, boron trichloride, tin tetrachloride, methyltrichlorosilane, or an acid chloride, among others. The most commonly used reagents, thionyl chloride and phosphorus pentachloride, may additionally cleave acrylate esters, forming acid chlorides, and all act as initiators for polymerization (see T. Sengupta et al, Journal of the Indian Chemical Society; 53:7, 726-7 (1976)). Benzyl chloride and acid chlorides are less effective in exchange or substitution reactions unless catalyzed by the presence of a strong Lewis acid type catalyst such as aluminum trichloride or boron trichloride. However, strong Lewis acids have the potential to catalyze reactions involving the acrylate functionality. A presently preferred reaction couple for the exchange reaction is acetyl chloride and a weak Lewis acid catalyst, preferably ferric chloride, which does not cleave the acrylate ester or induce polymerization.

The synthetic method described above is generally applicable for producing analogs and homologs of 3-methacryloxypropyldimethylchlorosilanes in purities greater than about 99%, more preferably greater than about 99.2%, even more preferably greater than about 99.3%, without detectable isomers or hydrogenated byproduct contamination, and which are suitable for use in the synthesis of high purity acrylate functional macromers. Other examples of compounds of similar functional structure that may be produced in high purity by the method described herein and which are free of detectable isomeric and hydrogenated byproducts include methacryloxymethyldimethylchlorosilane, 3-(acryloxy)propyldimethylchlorosilane, 11-(methacryloxy)undecyldimethylchlorosilane, and 3-(methacryloxy)propylmethyldichlorosilane. While analogous bromosilanes may be prepared by analogous methods, they are of less utility primarily due to economics.

Another indirect indication of the purity of the end-cappers produced in this manner is the observation that less excess of end-capper over theoretical stoichiometry is required to terminate the living AROP polymerizations. For example, whereas a 2% excess over the theoretical amount of end-capper is required when the end-capper is conventionally produced by hydrosilylation, the high purity end-cappers described herein require only a 1% excess over the theoretical amount for terminating the polymerization.

Aspects of the disclosure also relate to methods for producing high purity (meth)acryloxyalkylmethylsiloxane macromers and copolymers derived from the high purity (meth)acryloxyalkylmethyldichlorosilanes described above. Asymmetric macromers are typically prepared by initiating polymerization with a lithium dimethylsilanolate formed by the reaction of an alkyl lithium reagent with a strained cyclic siloxane, most commonly hexamethylcyclotrisiloxane. The lithium silanolate can be isolated or formed in situ. In the presence of a strained cyclic with a promoter, typically an aprotic polar material such as dimethylformamide or tetrahydrofuran, the ring-opening polymerization with additional strained cyclic siloxanes proceeds. Finally, end-capping of the polymer with a chlorosilane such as the most commonly used 3-(methacryloxy)propyldimethylchlorosilane completes the formation of the macromer. Symmetric macromers are formed similarly, but a dichlorosilane couples rather than terminates the reaction. These macromers and copolymers have a purity of greater than about 99%, more preferably greater than about 99.2%, even more preferably greater than about 99.3%, contain less than about 0.1 wt. % hydrogenated impurities and less than about 0.1 wt. % isomeric impurities, and have a molecular weight less than about 5,000 Daltons, more preferably less than about 1,000 Daltons.

Further aspects of the disclosure relate to methods for producing high purity (meth)acrylate functional macromers derived from the high purity end-cappers, including meth(acryloxy)methyl terminated macromers which have not been previously prepared. Specifically, these macromers may be produced using AROP procedures which are well known in the art and employing the high purity end-cappers described herein.

For example, a method for synthesizing a high purity (meth)acryloxyalkyl dimethyl functional asymmetric polysiloxane macromer comprises performing living anionic ring-opening polymerization using hexamethylcyclotrisiloxane as a starting material and the acryloxyalkyldimethylchlorosilane as previously described as an end-capper. In a preferred embodiment, the polysiloxane is a monomethacryloxypropyl terminated polydimethylsiloxane. The resulting polysiloxane is substantially free of non-polymeric polysiloxanes and contains less than about 0.1 wt. % impurities (or less than about 0.05 wt. % in a preferred embodiment) containing hydrogenated derivatives or isomers of the (meth)acryloxyalkyl functionality. Similarly, symmetric polysiloxane macromers may be derived from 3-(methacryloxypropyl)methyldichlorosilane.

The invention will now be described in connection with the following, non-limiting examples.

### Example 1 (Comparative): Synthesis of Methacryloxvpropyldimethylchlorosilane

Allylmethacrylate (1261 g, 10.0 mol) and BHT (4 wt %, 83.9 g) were charged to a reactor and a 02/Ar sparge was initiated. The reaction mixture was heated to 75° C., then Karstedt catalyst (2% Pt concentration in xylene, 1 ml) was added. Dimethylchlorosilane (969.8 g, 10.3 mol) was added dropwise over 6 hours while keeping pot temperature between 65-85° C. The resulting reaction mixture was stirred at 80° C. for 1 hour. Phenothiazine (5 wt %) was added to the reaction mixture and purified using a wiped film evaporator to afford a clear colorless liquid (1100 g, 50%). Analytical data: ¹H NMR (400 MHz, CDCl3) δ 6.10 (s, 1H), 5.56 (s, 1H), 4.15-4.12 (t, J=7.2 Hz, 2H), 1.94 (s, 3H), 1.78 (m, 2H), 0.88 (m, 2H), 0.43 (s, 3H); FTIR (cm⁻¹): 2958.43, 2925.56, 2892.7, 1716.86, 1638.17, 1452.32, 1407.43, 1319.71, 1295.06, 1254.91, 1157.04, 1064.03, 1011.38, 938.82, 846.93; GC-TCD: purity—88.85%, β-isomer—2.01%, isobutyroxypropyldimethylchlorosilane—0.88%; GC-MS m z: 220 (M), 205 (M−Me). When the hydrolysis (disiloxane) product which formed during analysis was added back in in order to remove artifact disiloxanes formed during sample handling, the purity of the product was 89.7%.

### Example 2: Synthesis of 3-Methacryloxvpropyldimethylethoxysilane

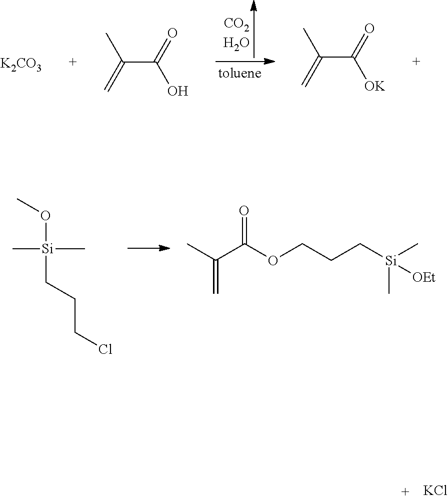

A 2 L 4-neck flask was equipped with a mechanical stirrer, heating mantle, addition funnel, pot thermal probe, fritted glass dispersion tube and Dean-Stark trap with water-cooled condenser. Di-t-butylhydroxytoluene (BHT) (4.19 g, 3.50 wt %) and toluene (960 g) were charged to the reactor. Stirring was initiated and potassium carbonate (109.1 g, 7.67 mol) was added. The slurry was heated to 80° C. with an O₂/Ar sparge and then methacrylic acid (119.9 g, 1.40 mol) was added dropwise at 100° C. over 2 hours. Carbon dioxide gas evolution was observed, and water was removed by the Dean-Stark trap under refluxing conditions. An azeotrope was observed starting at 90° C. After removing all water byproduct, tetrabutylphosphonium chloride (50% in toluene) (29.5 g, 0.031 mol) and 3-chloropropyldimethylethoxysilane (240.0 g, 1.33 mol) were added to the flask. The reaction mixture was heated at reflux for 3 hours and then cooled to room temperature. The reaction mixture was filtered. The filtrate was concentrated in vacuo and 5 wt % phenothiazine was added. The product was then purified by wiped film evaporation at 0.6-0.7 mmHg vacuum, with a 64-5° C. jacket temperature and a cold finger temperature of 30° C. with a product:residue split of 4:1 to afford the final product, 3-methacryloxypropyldimethylethoxysilane, as a clear colorless liquid (202.6 g, 66.2%). Analytical data: ¹H NMR (400 MHz, CDCl₃) δ 6.08 (s, 1H), 5.55 (s, 1H), 4.07-4.10 (t, J=7.2 Hz, 2H), 3.61-3.66 (q, J=13.6 Hz, 2H), 1.91 (s, 3H), 1.63-1.73 (m, 2H), 1.12-1.20 (t, J=6.8 Hz, 3H), 0.6 (m, 2H), 0.09 (S, 6H); FTIR (cm⁻¹): 2956.15, 2927.88, 2893.38, 1718.05, 1638.46, 1451.95, 1389.58, 1320.36, 1294.94, 1250.75, 1158.40, 1105.72, 1077.42, 937.89, 836.16; GC-TCD: purity—99.3%; GC-MS m/z: 229.2 (M), 215.1 (M−Me), 184.1 (M−OEt). The level of β-isomer and isobutyroxypropyldimethylethoxysilane were both below the level of detection by GC and GC-MS using a capillary column, i.e., less than 0.05%

### Example 3: Synthesis of 3-Methacryloxypropyldimethylchlorosilane

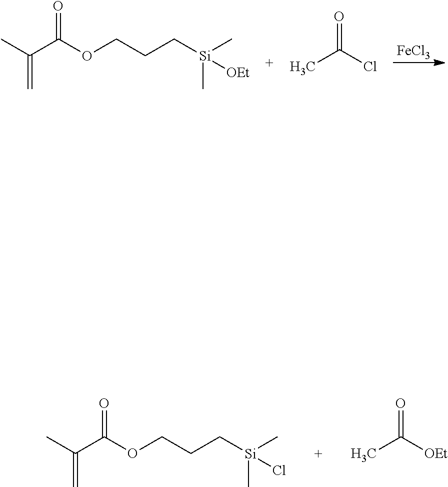

A 1 L 4-neck reactor was equipped with a magnetic stirrer, pot thermal probe, cooling bath, addition funnel, packed column, and distillation head with N₂. Ferric chloride, anhydrous, (1.40 g, 0.01 mol) and acetyl chloride (123.6 g, 1.58 mol) were charged to the reactor. 3-Methacryloxypropyldimethylethoxysilane as prepared in Example 2 inhibited with 1 wt % BHT (345.5 g, 1.50 mol) and phenothiazine (1.50 g, 0.01 mol) were added dropwise to the reaction mixture at a rate to maintain the reaction temperature at 20 to 25° C. An exothermic reaction was observed, and the color of the mixture changed from yellow to brown. (When the reaction was run without a cooling bath, a temperature rise of 30-40° C. was observed.) The resulting reaction mixture was stirred at room temperature for 12 hours. The mixture was concentrated in vacuo at 5 mmHg at a maximum temperature of 80° C. and purified by wiped film evaporation (with 5 wt % phenothiazine, 45-48° C., 0.5 mmHg, cold finger—25° C., split—3:1) to afford the product as a clear colorless liquid (270.4 g, 81.7%). GC-TCD: purity 98.91%. When the hydrolysis (disiloxane) product which formed during analysis was added back in in order to remove artifact disiloxanes formed during sample handling, the purity of the product was 99.3%. BHT (4 wt %) was added to the final product as an inhibitor. Analytical data: ¹H NMR (400 MHz, CDCl₃) δ 6.10 (s, 1H), 5.56 (s, 1H), 4.15-4.12 (t, J=7.2 Hz, 2H), 1.94 (s, 3H), 1.78 (m, 2H), 0.88 (m, 2H), 0.43 (s, 3H); FTIR (cm⁻¹): 2958.43, 2925.56, 2892.7, 1716.86, 1638.17, 1452.32, 1407.43, 1319.71, 1295.06, 1254.91, 1157.04, 1064.03, 1011.38, 938.82, 846.93; GC-MS m z: 220 (M), 205 (M−Me). Isobutyroxypropyldimethylchlorosilane and 1-methyl-2-methacryloxyethyldimethylchlorosilane were not observed to the limit of detection, 0.05%.

### Example 4: Synthesis of (Methacryloxymethyl)dimethylethoxysilane

A 22 L 4-neck flask was equipped with a mechanical stirrer, heating mantle, addition funnel, pot thermal probe, fritted glass dispersion tube and distillation head mounted on a 500 cm packed column. The flask was charged with 3000 ml of cyclohexane and 3718 g of a solution of 32% potassium methoxide in methanol. Stirring and a below liquid surface air sparge were initiated. Methacrylic acid (1439 ml, inhibited with BHT) was added through an addition funnel, maintaining the temperature below 60° C. After addition was completed, the pH was >9. The flask was then heated to remove methanol. When the pot temperature reached 71-73° C., methanol was removed from the pot and the cyclohexane in the Dean-Stark trap was clear. Approximately 100 ml of clear cyclohexane was not returned to the pot. After all of the methanol was removed and the flask cooled to room temperature, chloromethyldimethylethoxysilane (2119 ml) was added into flask through the addition funnel, followed by 69.7 g of tetrabutylammonium bromide. The flask was heated to 80-90° C. for 20 hours, at which time all raw material had reacted. After the reaction was complete, the mixture was filtered, the salts were rinsed twice with 1 L portions of cyclohexane, and the filtrate was concentrated. 1 g methyl ether of hydroquinone (MEHQ) and 1 g phenothiazine were added to the concentrate. The product was distilled through a 0.25 m packed column under 0.3 mmHg vacuum at 62-4° C. It was inhibited for storage with 20 ppm MEHQ and stored at <5° C.

### Example 5: Synthesis of (Methacryloxymethyl)dimethylchlorosilane

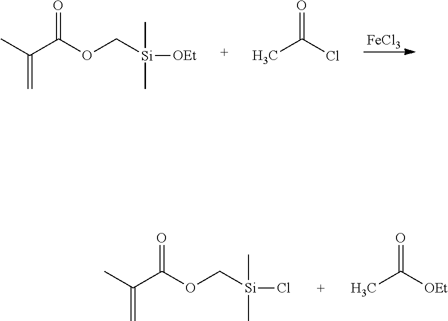

Under conditions similar to Example 3, (methacryloxymethyl)dimethylchlorosilane was prepared from the product of Example 4. A 500 mL 4-neck flask was equipped with magnetic stirrer, pot thermal probe, cooling bath, addition funnel, packed column, and distillation head protected with N₂. Ferric chloride (0.57 g, 0.003 mol) and acetyl chloride (40.6 g, 0.52 mol) were charged to the reactor. A premix of 3-methacryloxymethyldimethylethoxysilane (101 g, 0.50 mol) and phenothiazine (0.5 g, 0.5 wt %) was added dropwise to the reaction mixture at a rate to maintain the reaction temperature between 20 to 25° C. The exothermic reaction was observed and the color of the mixture changed from yellow to brown. The resulting reaction mixture was stirred at room temperature for 12 hours. The mixture was concentrated in vacuo with O₂/Ar sparge, and 0.5 wt % phenothiazine was added. The product was purified by distillation at 3-4 mmHg and 57-59° C. to afford the final product, 3-methacryloxymethyldimethylchlorosilane, as a clear colorless liquid (22.0 g, 22.8%). Analytical data: ¹H NMR (400 MHz, CDCl₃) δ 6.12 (s, 1H), 5.62 (s, 1H), 2.98 (s, 2H), 1.89 (s, 3H), 0.42 (s, 6H); FTIR (cm⁻¹): 2963.01, 1698.46, 1635.40, 1452.12, 1400.94, 1379.80, 1331.06, 1306.77, 1255.92, 1164.14, 1107.79, 1007.47, 945.94, 867.54, 821.31, 760.86, 680.83, 650.27, 596.07, 473.47; GC-TCD: purity—99.2%; GC-MS m z: 192 (M), 177 (M−Me), 157 (M−Cl). The level of isobutyroxymethyldimethylchlorosilane was below the level of detection by GC and GC-MS using a capillary column, i.e., less than 0.1%

### Example 6: Synthesis of Monobutyl-, monomethacryloxypropyl-terminated Polydimethylsiloxane

Hexamethylcyclotrisiloxane (D3, 204.2 g, 0.92 mol) and hexanes (134.5 g, 2.62 mol) were added to a 1 L round bottom flask containing a magnetic stir bar. The flask was sparged with nitrogen and the reaction mixture was stirred at room temperature for 2 h. n-Butyl lithium (2.6 M in hexane, 69.3 g, 0.26 mol) was added to the reaction flask via addition funnel and the solution was stirred for 1 h, followed by the addition of dimethylformamide (DMF, 18.2 g, 0.25 mol) to the solution as a polymerization promoter. After 3 h of stirring, the polymer was terminated with 3-methacryloxypropyldimethylchlorosilane (prepared in Example 3) to obtain monobutyl-, monomethacryloxypropyl-terminated polydimethylsiloxane. The solution was then stirred overnight and washed with 178 g deionized water. The aqueous and organic layers were separated, and the organic layer was dried with sodium sulfate, filtered, and stripped under vacuum at 95° C. with a dry air sparge.

### Example 7: Comparison of Comparative and Inventive Products

Macromers derived from 3-methacryloxypropyldimethylchlorosilane produced by hydrosilylation (comparative, Example 1) and the inventive high purity material prepared in Example 3 were analyzed and are compared in the following Table:

| | End capper composition (%) | | | % end-capper excess |
|---|---|---|---|---|
| | Main | | Isobutyroxypropyl- | of theory for |
| End-capper grade | product | β-Isomer | dimethylethoxysilane | termination in AROP |
| End-capper by | 89.7 | 2 | 0.9 | 2 |
| hydrosilylation | | | | |
| (comparative) | | | | |
| High Purity End- | 99.3 | Not detected | Not detected | 1 |
| capper (inventive) | | | | |

### Comparative Example 8: Example 1 of U.S. Pat. No. 5,493,039 of Okawa

3-Methacyloxpropyldimethylchlorosilane was synthesized as described in Example 1 of U.S. Pat. No. 5,493,039 of Okawa using the same conditions and scale, except that the water content of the allyl methacrylate was 37 ppm and not 171 ppm. Analysis of the product revealed the presence of isobutyroxypropyldimethylchlorosilane (0.59%) and the 0-isomer (1.47%). The purpose of this comparative example was to demonstrate that, although not reported by Okawa, the reduction product was in fact generated during this hydrosilylation method. The level of isobutyroxymethyldimethylchlorosilane was below the level of detection by GC and GC-MS using a capillary column, i.e., less than 0.05%

### Comparative Example 9: Practical Example 1 of U.S. Pat. No. 5,811,565 of Mikami

3-Methacyloxpropyldimethylchlorosilane was synthesized as described in Practical Example 1 of U.S. Pat. No. 5,811,565 of Mikami except that phenothiazine replaced 3,5-di-t-butyl-4-hydroxyphenylmethyldimethylammonium chloride as an inhibitor and the reaction mixture was sparged with O₂/Ar during hydrosilylation. Analytical data before the addition of the copper reagent showed the presence of both isobutyroxypropyldimethylchlorosilane (0.26%) and β-isomer (1.87%). After the addition of copper(II) chloride, a reduction in the content of the β-isomer to below 1.0% was observed, but no change in the isobutyroxypropyldimethylchlorosilane content was observed. The purpose of this comparative example was to demonstrate that the reduction product was in fact generated during this hydrosilylation method, although not reported by Mikami. The level of isobutyroxymethyldimethylchlorosilane was below the level of detection by GC and GC-MS using a capillary column, i.e., less than 0.05%

It may be clearly observed that the 3-methacryloxypropyldimethylchlorosilane prepared by the method according to the present disclosure not only has dramatically higher purity than the analogous material prepared by traditional hydrosilylation, but also has no detectable p-isomer or hydrogenated byproduct. Further, the percentage excess required when using this compound as an end-capper for AROP is reduced by half.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. An acryloxyalkyldimethylchlorosilane having a purity of at least about 99% and containing less than about 0.1 wt. % hydrogenated byproducts and less than about 0.1 wt. % isomeric byproducts.

2. The acryloxyalkyldimethylchlorosilane according to claim 1, wherein the acryloxyalkyldimethylchlorosilane contains less than about 0.05 wt. % hydrogenated byproducts and less than about 0.05 wt. % isomeric byproducts.

3. The acryloxyalkyldimethylchlorosilane according to claim 1, wherein the acryloxyalkyldimethylchlorosilane is a (meth)acryloxyalkyldimethylchlorosilane.

4. The acryloxyalkyldimethylchlorosilane according to claim 3, wherein the acryloxyalkyldimethylchlorosilane contains less than about 0.05 wt. % isobutyroxypropyldimethylchlorosilane and less than about 0.05 wt. % 1-methyl-2-methacryloxyethyldimethylchlorosilane.

5. The acryloxyalkyldimethylchlorosilane according to claim 1, wherein the purity is greater than about 99.3%.

6. The acryloxyalkyldimethylchlorosilane according to claim 1, wherein the acryloxyalkyldimethylchlorosilane is 3-methacryloxypropyldimethylchlorosilane, methacryloxymethyldimethylchlorosilane, 3-(acryloxy)propyldimethylchlorosilane, 11-(methacryloxy)undecyldimethylchlorosilane, or 3-(methacryloxy)propylmethyldichlorosilane.

7. A method of synthesizing a high purity acryloxyalkyldimethylchlorosilane comprising:
(a) reacting an acrylate salt with a haloalkyldimethylalkoxysilane to form an acryloxy-substituted alkyldimethylalkoxysilane; and
(b) displacing the alkoxy group in the acryloxy-substituted alkyldimethylalkoxysilane using a chloride-containing compound to form the acryloxyalkyldimethylchlorosilane.

8. The method according to claim 7, wherein step (a) is a phase transfer catalyzed reaction.

9. The method according to claim 7, wherein step (a) comprises (i) reacting a halide salt with methacrylic acid to form the acrylate salt; and (ii) reacting the acrylate salt with the haloalkyldimethylalkoxysilane.

10. The method according to claim 7, wherein step (b) is an exchange or substitution reaction.

11. The method according to claim 7, wherein step (b) comprises reacting the acryloxy-substituted alkyldimethylalkoxysilane with an acetyl chloride and a weak Lewis acid catalyst.

12. The method according to claim 7, wherein the acryloxyalkyldimethylchlorosilane is a (meth)acryloxyalkyldimethylchlorosilane and the product of step (a) is a (meth)acryloxyalkyldimethylalkoxysilane.

13. The method according to claim 7, wherein the acryloxyalkyldimethylchlorosilane is 3-methyacryloxypropyldimethylchlorosilane, methacryloxymethyldimethylchlorosilane, 3-(acryloxy)propyldimethylchlorosilane, 11-(methacryloxy)undecyldimethylchlorosilane, or 3-(methacryloxy)propylmethyldichlorosilane.

14. The method according to claim 7, wherein the acryloxyalkyldimethylchlorosilane has a purity of greater than about 99%.

15. The method according to claim 14, wherein the acryloxyalkyldimethylchlorosilane has a purity of greater than about 99.3%.

16. The method according to claim 7, wherein the acryloxyalkyldimethylchlorosilane contains less than about 0.1 wt. % hydrogenated byproducts and less than about 0.1 wt. % isomeric byproducts.

17. The method according to claim 16, wherein the acryloxyalkyldimethylchlorosilane contains less than about 0.05 wt. % hydrogenated byproducts and less than about 0.05% isomeric byproducts.

18. The method according to claim 7, wherein the acryloxyalkyldimethylchlorosilane is a (meth)acryloxyalkyldimethylchlorosilane and contains less than about 0.05 wt. % isobutyroxypropyldimethylchlorosilane and less than about 0.05 wt. % 1-methyl-2-methacryloxyethyldimethylchlorosilane.

19. A method for synthesizing a high purity (meth)acryloxyalkyldimethyl functional polysiloxane macromer comprising performing living anionic ring-opening polymerization using hexamethylcyclotrisiloxane as a starting material and the acryloxyalkyldimethylchlorosilane according to claim 1 as a termination reagent.

20. The method according to claim 19, wherein the polysiloxane is a monomethacryloxypropyl terminated polydimethylsiloxane.

21. The method according to claim 19, wherein the polysiloxane is substantially free of non-polymeric polysiloxanes.

22. The method according to claim 19, wherein the polysiloxane contains less than about 0.1 wt. % impurities containing hydrogenated derivatives or isomers of the (meth)acryloxyalkyl functionality.

23. A methacrylate-functional macromer or copolymer derived from an acryloxyalkyldimethylchlorosilane, wherein the macromer or copolymer has a purity of at least about 99%.

24. The macromer or copolymer according to claim 23, wherein the macromer or copolymer contains less than about 0.1 wt. % hydrogenated derivatives of the methacrylate functionality.

25. The macromer or copolymer according to claim 24, wherein the macromer or copolymer contains less than about 0.05 wt. % hydrogenated derivatives of the methacrylate functionality.

26. The macromer or copolymer according to claim 23, having a molecular weight of less than about 5,000 Daltons.

27. The methacrylate-functional macromer or copolymer derived from an acryloxyalkyldimethylchlorosilane according to claim 23, wherein the macromer or copolymer has a purity of at least about 99.3%.
